(19) United States
(12) Patent Application Publication
(10) Pub. No.: US 2025/0197246 A1
(43) Pub. Date: Jun. 19, 2025

(54) CATHODE ACTIVE MATERIAL, CATHODE, LITHIUM ION BATTERY, AND METHOD FOR PRODUCING CATHODE ACTIVE MATERIAL

(71) Applicant: TOYOTA JIDOSHA KABUSHIKI KAISHA, Toyota-shi (JP)

(72) Inventors: Hiroo NOZAKI, Chiryu-shi (JP); Ryosuke OHSAWA, Okazaki-shi (JP); Taku KINOSHITA, Toyota-shi (JP)

(73) Assignee: TOYOTA JIDOSHA KABUSHIKI KAISHA, Toyota-shi (JP)

(21) Appl. No.: 18/950,808

(22) Filed: Nov. 18, 2024

(30) Foreign Application Priority Data
Dec. 15, 2023 (JP) 2023-212062

(51) Int. Cl. C01G 53/00; H01M 10/0525

(52) U.S. Cl. CPC C01G 53/50; H01M 10/0525; C01P 2006/40

(57) ABSTRACT

A cathode active material comprising a lithium metal-containing composite oxide, wherein the lithium metal-containing composite oxide is represented by the following formula (1):

LiₐNiₓCo_{y}Mn_{z}M_{c}O₂ (1),

wherein x, y, z, a and b are x+y+z+b=1, 0≤x≤1,0≤y≤1, 0≤z≤1, 0<a≤1, 0<b≤0.15, M is a transition element the number of electrons of the lanthanide or d orbital is 4 or less.

### CROSS-REFERENCE TO RELATED APPLICATION

This application claims priority to Japanese Patent Application No. 2023-212062 filed on Dec. 15, 2023, incorporated herein by reference in its entirety.

### BACKGROUND

### 1. Technical Field

The present disclosure relates to a cathode active material, a cathode, a lithium ion battery, and a method for producing a cathode active material.

### 2. Description of Related Art

Japanese Unexamined Patent Application Publication No. 2013-229339 (JP 2013-229339 A) discloses that a specific element is added to a lithium-metal composite oxide containing lithium, nickel, cobalt, and manganese for the purpose of increasing a battery capacity, etc.

### SUMMARY

In JP 2013-229339 A, improvement in the battery capacity is achieved by adding the specific element. However, there is room for improvement in terms of cracking of cathode active material particles, which is a main cause of deterioration of the cathode active material.

An object of the present disclosure is to provide a cathode active material, a cathode, a lithium ion battery, and a method for producing a cathode active material in which expansion and contraction are suppressed.

1. A cathode active material includes

a lithium metal-containing composite oxide.
The lithium metal-containing composite oxide is represented by the following formula (1):

LiₐNiₓCo_{y}Mn_{z}M_{b}O₂ (1)

where
x, y, z, a, and b satisfy relationships of x+y+z+b=1, 0≤x≤1, 0≤y≤1, 0≤z≤1, 0<a≤1, and 0<b≤0.15, and
M is a lanthanide or a transition element in which the number of electrons in d orbital is four or less.

The element M that is the lanthanide or the transition element in which the number of electrons in d orbital is four or less does not reduce the capacity even if the cathode active material is doped because the electrons contribute to charge and discharge. It is considered that the spatial extension of d/f electrons supports the structure of the cathode active material even if the lithium-filling ratio is low.

2

[symbol]

In the cathode active material according to 1,
the M may be at least one kind selected from the group consisting of Nd, Sm, Gd, and La.

3.

[symbol]

A cathode includes
the cathode active material according to 1 or 2.

4.

[symbol]

A lithium ion battery includes
the cathode according to 3.

5.

[symbol]

A method for producing a cathode active material includes:
producing a precursor containing M;
mixing the precursor and lithium to produce a lithium mixture;
firing the lithium mixture to produce a lithium metal-containing composite oxide; and
crushing the lithium metal-containing composite oxide to produce a cathode active material.
The firing is performed at a temperature of 600° C. to 700° C. for 48 to 52 hours.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic flowchart of a method for producing a cathode active material according to the present embodiment;

FIG. 2 is a schematic diagram illustrating an example of the lithium ion battery of the present embodiment;

FIG. 3 is a schematic diagram illustrating an example of an electrode body according to the present embodiment;

FIG. 4 is a plot of c-axis length versus b of the cathode active materials from Nos. 2 to 16;

FIG. 5 is a table showing sample configurations and evaluations of Examples and Comparative Examples; and

FIG. 6 is a table showing sample configurations and evaluation results of Examples and Comparative Examples.

### DETAILED DESCRIPTION OF EMBODIMENTS

Hereinafter, embodiments of the present disclosure (hereinafter can be abbreviated as the “present embodiment”) and examples of the present disclosure (hereinafter can be abbreviated as the “present example”) will be described. However, the present embodiment and the present example do not limit the technical scope of the present disclosure.

### Cathode Active Material

The cathode active material of the present embodiment is a cathode active material including a lithium metal-containing composite oxide. The cathode active material of the present embodiment may be a cathode active material made of a lithium metal-containing composite oxide. The cathode active material is particles. The cathode active material may have any size. The cathode active material may have, for example, a D50 of 1 μm or more and 30 μm or less, or may have a D50 of 5 μm or more and 20 μm or less. In the present specification, “D50” is defined as a particle size in which the cumulative frequency from the smaller particle size becomes 50% in the volume-based particle size distribution. The volume-based particle size distribution can be measured by a laser diffraction particle size distribution measuring device.

### Particle Structure

The cathode active material includes secondary particles in which a plurality of primary particles is aggregated. The cathode active material may consist essentially of secondary particles, for example. The secondary particles are formed by aggregation of 50 or more primary particles. The number of primary particles contained in the secondary particles is measured in SEM images (scanning electron microscope) of the secondary particles. The magnification of SEM images may be, for example, 10000 to 30000 times. The secondary particles may be formed, for example, by aggregation of 100 or more primary particles. In the secondary particles, there is no upper limit on the number of primary particles. The secondary particles may be formed, for example, by aggregation of not more than 10000 primary particles. The secondary particles may be formed, for example, by aggregation of not more than 1000 primary particles. The primary particles may have any shape. The primary particles may be, for example, spherical, columnar, lumpy, etc.

### Composition

The cathode active material can reversibly occlude and release lithium ions. The cathode active material may have any crystal structure. The cathode active material may have, for example, a layered rock salt type structure, a spinel type structure, an olivine type structure, or the like. The cathode active material may have any chemical composition. The chemical composition of the cathode active material can be measured by, for example, high-frequency inductively coupled plasma-emission spectroscopy (ICP-AES).

The cathode active material includes a lithium metal-containing composite oxide. The lithium metal-containing composite oxide has a composition represented by the following formula (1).

LiₐNiₓCo_{y}Mn_{z}M_{b}O₂ (1)

In the above formula (1), x, y, z, a, and b satisfy relationships of x+y+z+b=1, 0≤x≤1, 0≤y≤1, 0≤z≤1, 0<a≤1, and 0<b≤0.15. M is a lanthanide or a transition element in which the number of electrons in the d orbital is 4 or less.

The element M, which is a transition element in which the number of electrons in the lanthanoid or the d orbital is 4 or less, does not reduce the capacity even if the cathode active material is doped because the electrons contribute to charge and discharge. In addition, the spatial expansion of d/f electrons supports the structure of the cathode active material even when Li fill ratio is low. Therefore, by adding the element M, expansion and contraction of the cathode active material due to charge and discharge can be suppressed.

Examples of the element M include lanthanum (La), cerium (Ce), prascodymium (Pr), neodymium (Nd), promethium (Pm), samarium (Sm), curopium (Eu), gadolinium (Gd), and terbium (Tb). Examples of the element M include dysprosium (Dy), holmium (Ho), erbium (Er), thulium (Tm), ytterbium (Yb), lutetium (Lu), scandium (Sc), titanium (Ti), and vanadium (V). Examples of the element M include chromium (Cr), yttrium (Y), zirconium (Zr), niobium (Nb), molybdenum (Mo), hafnium (Hf), tantalum (Ta), and tungsten (W). Among them, La, Nd, Sm and Gd are preferable as the clement M from the viewpoint of suppressing a decrease in capacitance.

In the above formula (1), b satisfies the relationship of 0<b≤0.15. When b is more than 0.15, the ratio of the element M is large, and thus there is a possibility that the structure of the cathode active material cannot be supported. b may be 0.01 or more and may be 0.02 or more. b may be 0.10 or less, may be 0.07 or less, or may be 0.04 or less.

### Method for Producing Cathode Active Material

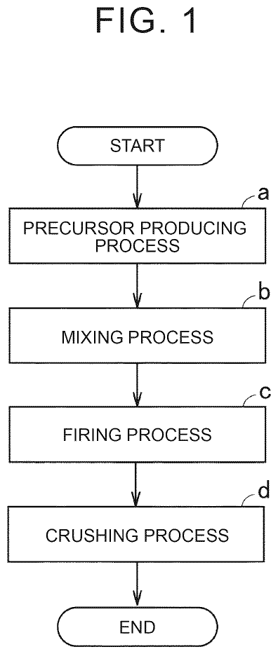

FIG. 1 is a schematic flowchart of a method for producing a cathode active material according to the present embodiment. Hereinafter, the “method for producing a cathode active material according to the present embodiment” may be abbreviated as “the present production method”. The production method includes at least (a) a precursor producing process, (b) a mixing process, (c) a firing process, and (d) a crushing process.

### (a) Precursor Producing Process

In the precursor producing process, a precursor (composite hydroxide) containing a salt of the element M is produced. The precursor is produced, for example, by the following procedure.

For example, nickel salt, cobalt salt, by the salt of manganese salt and clement M is dissolved in water at a predetermined ratio, acid aqueous solution is produced. Examples of the nickel salt include, but are not limited to, nickel sulfate, nickel nitrate, and nickel chloride. Examples of the cobalt salt include, but are not limited to, cobalt sulfate, cobalt nitrate, and cobalt chloride. Examples of the manganese salt include, but are not limited to, manganese sulfate, manganese nitrate, and manganese chloride. The salt of the element M is not particularly limited, for example, a sulfate of the element M, nitrate of the clement M, hydrochloride of the element M and the like can be used.

The nickel salt, the cobalt salt, the manganese salt and the M element salt are mixed so that the molar ratio of nickel, cobalt, manganese and the M element is “x:y:z:b”. x, y, z, and b satisfy relationships of x+y+z+b=1, 0≤x≤1, 0≤y≤1, 0≤z≤1, and 0<b≤0.15.

For example, a neutralization reaction occurs when an aqueous alkali solution is added dropwise to an acidic aqueous solution. Aqueous alkaline solutions are prepared, for example, by mixing water, an ammonium-ion feed, and a pH modifier. The ammonium ion supplier is not particularly limited, and for example, aqueous ammonia, aqueous ammonium sulfate, or the like can be used. pH adjusting agent is not particularly limited, and for example, sodium hydroxide, potassium hydroxide, and the like can be used. The neutralization reaction produces a precipitate. The precipitate comprises a composite hydroxide.

For example, the precipitate is washed, filtered, and dried to produce a dried product (precursor). The washing is performed, for example, by filtering the precipitate to remove the composite hydroxide, and then washing with water. The drying is performed at a predetermined temperature for a predetermined time. The drying temperature may be, for example, 100 to 150° C. The drying time may be, for example, 1 to 24 hours.

### (b) Mixing Process

In the mixing process, a lithium salt is mixed with the precursor obtained in the precursor producing process to prepare a lithium mixture. Examples of the lithium salt include, but are not limited to, lithium carbonate, lithium hydroxide, and lithium nitrate.

### (c) Firing Process

In the firing process, a lithium metal-containing composite oxide is produced by firing the lithium mixture obtained in the mixing process. For firing, for example, a muffle furnace or the like may be used. The calcination may be carried out, for example, under an inert gas atmosphere, under dry air, or under an oxygen atmosphere.

The firing temperature may be, for example, 500 to 1000° C. When the firing temperature is less than 500°° C., Li and the precursor do not sufficiently react with each other, and excessive Li or unreacted precursor may remain, or the crystallinity of the obtained lithium metal-containing composite oxide may be insufficient. When the firing temperature exceeds 1000° C., the outer surface area of the obtained lithium metal-containing composite oxide decreases, or sintering of the secondary particles of the lithium metal-containing composite oxide abnormally occurs, and there is a possibility that the amorphous secondary particles increase.

The firing time may be, for example, 5 to 60 hours. When the firing time is less than 5 hours, Li and the precursor do not sufficiently react with each other, and excess Li or unreacted precursor may remain, or the crystallinity of the resulting lithium metal-containing composite oxide may be insufficient. When the firing temperature exceeds 60 hours, the outer surface area of the obtained lithium metal-containing composite oxide decreases, or sintering of the secondary particles of the lithium metal-containing composite oxide abnormally occurs, and there is a possibility that the amorphous secondary particles increase.

In the firing process, the firing temperature is preferably 600 to 700° C. and the firing time is preferably 48 to 52 hours. By performing the firing process under the conditions, the doping ratio of the M element is improved.

### (d) Crushing Process

In the crushing process, the lithium metal-containing composite oxide obtained by the firing process is crushed. Thus, a cathode active material having a desired particle diameter can be obtained. For crushing, for example, a jet mill or the like may be used. The disintegration may be carried out, for example, under an inert gas atmosphere or under a nitrogen atmosphere.

### Lithium Ion Battery

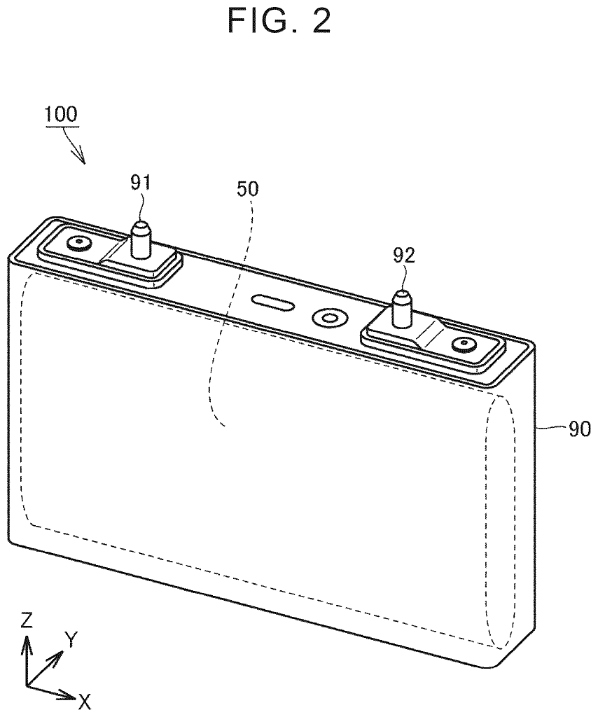

FIG. 2 is a schematic diagram illustrating an example of a lithium ion battery (hereinafter, may be abbreviated as “battery”) according to the present embodiment. The battery 100 includes a case 90. The case 90 has any form. The case 90 may have, for example, a rectangular shape or a cylindrical shape. The case 90 may be made of metal, for example, or may be a pouch made of aluminum (Al) laminated film. The case 90 may be provided with a cathode terminal 91 and a negative electrode terminal 92.

The case 90 houses the electrode body 50 and the electrolytic solution. The electrolytic solution is impregnated into the electrode body 50. The electrode body 50 is connected to the cathode terminal 91 and the negative electrode terminal 92.

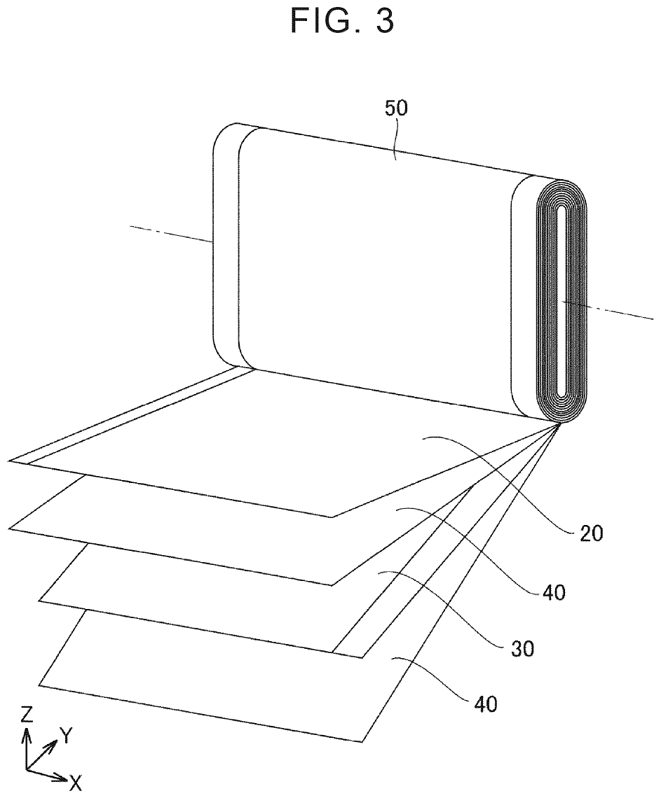

FIG. 3 is a schematic diagram illustrating an example of an electrode body according to the present embodiment. The electrode body 50 includes a cathode 20, a separator 40, and a negative electrode 30. The electrode body 50 has an arbitrary structure.

For example, the electrode body 50 may be of a wound type. Each of the cathode 20, the separator 40, and the negative electrode 30 may be a belt-shaped sheet. The electrode body 50 may be formed by, for example, laminating the cathode 20, the separator 40 (first sheet), the negative electrode 30, and the separator 40 (second sheet) in this order. After winding, the electrode body 50 may be formed into a flat shape.

### Cathode

The cathode 20 may include a cathode current collector and a cathode active material layer. The cathode current collector may include, for example, an aluminum (Al) foil or the like. The cathode active material layer includes the aforementioned cathode active material. As long as the cathode 20 includes the aforementioned cathode active material, the cathode 20 may include an additional cathode active material. The cathode active material layer may further include, for example, a conductive material, a binder, and the like.

The conductive material may include, for example, acetylene black (AB). The binder may include, for example, PVDF or the like. The blending amount of the conductive material and the binder may be, for example, 0.1 to 10 parts by mass with respect to 100 parts by mass of the cathode active material.

### Negative Electrode

The negative electrode 30 may include a negative electrode current collector and a negative electrode active material layer. The negative electrode current collector may include, for example, a copper (Cu) foil. The anode active material layer includes an anode active material. The negative electrode active material may include, for example, at least one selected from the group consisting of graphite, soft carbon, and hard carbon. The negative electrode active material layer may further include, for example, a conductive material, a binder, and the like.

The conductive material may include, for example, a carbon nanotube (CNT) or the like. The binder may include, for example, carboxymethylcellulose (CMC), styrene-butadiene rubber (SBR), and the like. The blending amount of the conductive material and the binder may be, for example, 0.1 to 10 parts by mass with respect to 100 parts by mass of the negative electrode active material.

### Separator

The separator 40 is porous. The separator 40 may pass through the electrolytic solution. The separator 40 separates the cathode 20 and the negative electrode 30 from each other. The separator 40 is electrically insulating. The separator 40 may include, for example, a polyolefin-based resin such as polyethylene (PE) or polypropylene (PP). The separator 40 may have, for example, a single-layer structure or a multi-layer structure. The separator 40 may consist of, for example, substantially PE layers, and may be formed by laminating PP layers, PE layers, and PP layers in this order. For example, a heat-resistant layer may be formed on the surface of the separator 40.

### Electrolytic Solution

The electrolyte solution includes solvents and Li salts. The solvent is aprotic. The solvent may comprise any component. The solvents may include, for example, at least one selected from the group consisting of ethylene carbonate (EC), dimethyl carbonate (DMC), and ethyl methyl carbonate (EMC).

Li salt is a supporting electrolyte. Li salt is dissolved in a solvent. Li salt may include, for example, at least one selected from the group consisting of LiPF₆ and LiBF₄. Li salt may have a molar concentration of, for example, 0.5 mol/L or more and 2.0 mol/L or less.

The electrolyte solution may further contain an optional additive. The electrolytic solution may contain, for example, 0.01% by mass or more and 5% by mass or less of an additive. The additive may include, for example, at least one selected from the group consisting of vinylene carbonate (VC), vinyl ethylene carbonate (VEC), and the like.

### No. 1

### Production of Cathode Active Material

### Precursor Producing Process

Acidic aqueous solutions were obtained by dissolving nickel sulfate and manganese sulfate in ion-exchanged water.

The reaction vessel was fed with ammonia water and stirred with a stirrer. Next, an aqueous alkaline solution was prepared by supplying an aqueous sodium hydroxide solution to the reaction vessel. While the aqueous alkali solution in the reaction vessel was stirred by the stirrer, the aqueous acid solution was added dropwise to the aqueous alkali solution. During the dropwise addition of the acidic aqueous solution, aqueous ammonia and aqueous sodium hydroxide were added as appropriate so that the ammonia level and pH of the reactant were constant.

The precipitate after the reaction was filtered, washed with water, and filtered again to obtain a composite hydroxide. The resulting composite hydroxide was dried at 120°° C. for 16 hours to obtain a precursor.

### Mixing Process

The precursor and lithium carbonate were mixed in a mortar to obtain a lithium mixture.

### Firing Process

The lithium mixture was calcined in a muffle furnace set at 600 to 700°° C. for 50 hours to obtain a lithium metal-containing composite oxide.

### Crushing Process

The lithium metal-containing composite oxide was crushed using a jet mill to obtain a cathode active material having a No. 1.

### Nos. 2-1, 2, 3, 4 to Nos. 16-1, 2, 3, 4

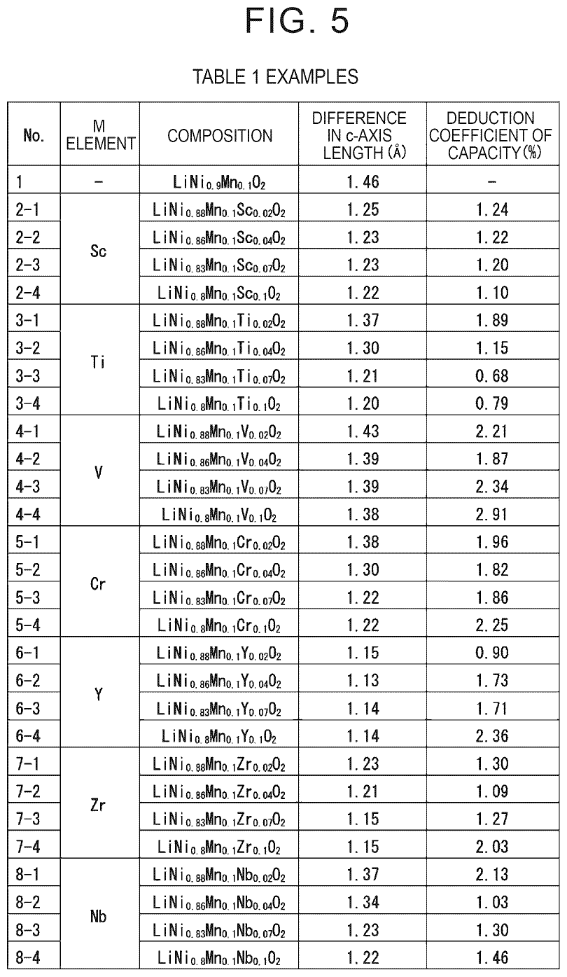

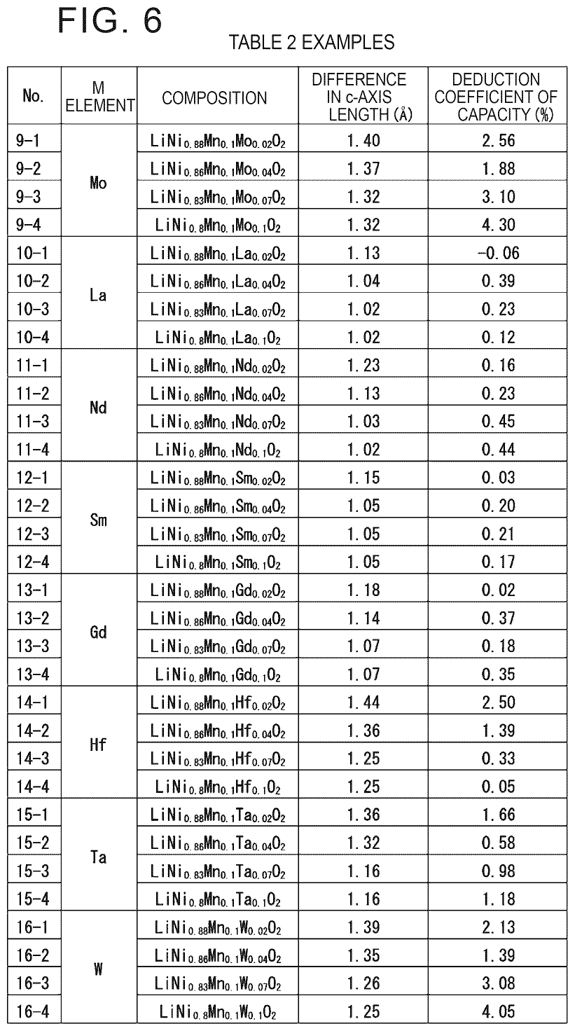

Nickel sulfate, manganese sulfate, and M element sulfate were dissolved in ion-exchanged water, and an acidic aqueous solution was obtained. Except for this change, a Nos. 16-1, 2, 3, 4 cathode active material was obtained from Nos. 2-1, 2, 3, 4 by the same process as that of No. 1. The M elements included in the cathode active materials of the respective No. are as shown in FIGS. 5 and 6.

### Manufacture of Lithium Ion Battery

As a material of the cathode, the cathode active materials from Nos. 1 to 16, AB as a conductive material, PVdF as a binder, and Al foil as a cathode current collector were prepared. A cathode was prepared using the above-described material.

Natural graphite as a negative electrode active material, CMC and SBR as a binder, and Cu foil as a negative electrode current collector were prepared. A negative electrode was prepared using the above-described material.

As separators, porous resins (PP/PE/PP) in which PP layers were laminated on both sides of PE layers were prepared. As an electrolyte solution, a mixed solvent containing EC, a DMC, and EMC was prepared by dissolving a support salt (LiPF₆) at a 1 mol/L level. The cathode, the negative electrode, the separator, and the electrolyte were used to produce 16 test batteries for evaluating No. 1.

### Evaluation

c-Axis Length

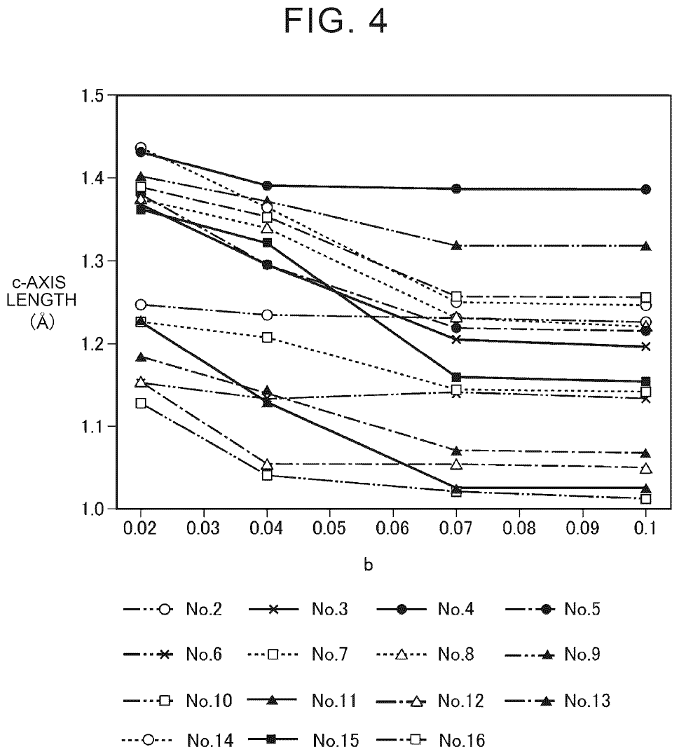

At an SOC of 100%, the cathode active material was recovered by disassembling the test cell. By an X-ray diffraction device, an X-ray diffraction pattern was obtained by irradiating the cathode active material (cathode active material having an SOC of 0%) of each No. after the production and the cathode active material of each No. after the recovery with X-rays under the following measurement conditions. From the obtained X-ray diffraction pattern, the crystal peak data was subjected to Rietveld analysis, and the c-axis length in the crystal was calculated by calculating the lattice constant. Then, the cathode active material c-axis length in SOC of 100% and the cathode active material c-axis length in SOC of 0% were determined to confirm the expansion and contraction of the cathode active material. The results are shown in FIGS. 4 to 6. It should be noted that “SOC (State of Charge)” indicates the percentage of the charge capacity of the battery at that point in time with respect to the full charge capacity of the battery.

### Measurement Conditions

X-ray power: 45 kV, 200 mA
X-ray source: CuKα ray (wavelength: 1.54051 Å), single crystal monochromator
Diffraction angle: 10° to 120° Temperature: room temperature (25° C.)
Scan speed: 1 sec/step
Further, the composition of each cathode active material was confirmed from the obtained X-ray diffraction pattern. The ratio of the M elements contained in each cathode active material was calculated from the difference in the c-axis length of each No. of cathode active material obtained above and the ionic radii of each M element. The composition of each cathode active material is shown in FIGS. 5 and 6.

### Deduction Coefficient of Capacity

The initial capacity (initial discharge capacity) of each test cell was measured by the following constant current-constant voltage charging and constant current discharging. In addition, the rate of decrease in the capacitance of the test cells other than No. 1 was calculated by Equation (2) below. The results are shown in FIGS. 5 and 6.

Constant current-constant voltage charge: Current=0.1C, Upper limit voltage=4.3, Cut current=0.02C

Constant current discharging: current=0.2C, cut-voltage=3 V (Initial Capacity of Test Battery of No. 1—Initial Capacity of Each Test Battery)/Initial Capacity of Test Battery of No. 1×100 (2)

### Results

As shown in FIGS. 4 to 6, the difference in the c-axis length of the cathode active material other than No. 1 containing the Melement was shorter than the difference in the c-axis length of the cathode active material in No. 1 not containing the M element. That is, it can be seen that the addition of the M element to the cathode active material suppresses the expansion and contraction of the cathode active material.

Further, as shown in FIGS. 5 and 6, by adding the M element to the cathode active material, the capacity of the test cell is reduced, in Nos. 10 to 13, the capacity reduction rate due to the addition of the M element is smaller than the capacity reduction rate of the other No. it can be seen. That is, it can be seen that the use of La, Nd, Sm and Gd as the M element not only suppresses the expansion and contraction of the cathode active material but also suppresses the decrease in the capacity of the batteries.

The present embodiment and the present example are illustrative in all respects. The present embodiment and the present example are not restrictive. The technical scope of the present disclosure includes all changes within the meaning and range equivalent to the description of the claims. For example, from the beginning, it is planned to extract an appropriate configuration from the present embodiment and the present example and combine them as appropriate.

What is claimed is:

1. A cathode active material comprising a lithium metal-containing composite oxide, wherein the lithium metal-containing composite oxide is represented by the following formula (1):
LiₐNiₓCo_{y}Mn_{z}M_{b}O₂ (1)
where
x, y, z, a, and b satisfy relationships of x+y+z+b=1, 0≤x≤1, 0≤y≤1, 0≤z≤1, 0<a≤1, and 0<b≤0.15, and
M is a lanthanide or a transition element in which the number of electrons in d orbital is four or less.

2. The cathode active material according to claim 1, wherein the M is at least one kind selected from the group consisting of Nd, Sm, Gd, and La.

3. A cathode comprising the cathode active material according to claim 1.

4. A lithium ion battery comprising the cathode according to claim 3.

5. A method for producing a cathode active material, the method comprising:
producing a precursor containing M;
mixing the precursor and lithium to produce a lithium mixture;
firing the lithium mixture to produce a lithium metal-containing composite oxide; and
crushing the lithium metal-containing composite oxide to produce a cathode active material, wherein
the firing is performed at a temperature of 600°° C. to 700° C. for 48 to 52 hours.
